(19) United States
(12) Patent Application Publication
(10) Pub. No.: US 2014/0047051 A1
(43) Pub. Date: Feb. 13, 2014

(54) METHOD AND SYSTEM FOR SENDING PROMPT INFORMATION TO SOCIAL NETWORKING SERVICES COMMUNITY USERS

(71) Applicants: Chun Li, Guangdong (CN); Yu Chen, Guangdong (CN)

(72) Inventors: Chun Li, Guangdong (CN); Yu Chen, Guangdong (CN)

(73) Assignee: Tencent Technology (Shenzhen) Company Limited, Guangdong (CN)

(21) Appl. No.: 13/984,088

(22) PCT Filed: Jul. 10, 2012
(86) PCT No.: PCT/CN2012/078414

§ 371 Date: Aug. 7, 2013

(30) Foreign Application Priority Data
Sep. 30, 2011 (CN) 201110299272.2

(51) Int. Cl. H04L 12/58

(52) U.S. Cl. CPC H04L 51/32
USPC 709/206

(57) ABSTRACT

A method for sending prompt information to Social Networking Services (SNS) community users comprises the following steps: acquiring the inactive users in an SNS community; acquiring the friend relationship chains of the inactive users; acquiring the active users in the friend relationship chains; acquiring the writing operations of the active users; sending prompt information related to the writing operations of the active users to the inactive users. The method described above for sending prompt information to SNS community users can increase the success rate for activating the inactive users, and thus effectively reducing the loss of the SNS community users. Besides, a system for sending prompt information to SNS community users is also provided.

### TECHNICAL FIELD

The present invention relates to the field of Internet technologies, in particularly to a method and system for sending prompt information to Social Networking Services (SNS) community users.

### TECHNICAL BACKGROUND

The traditional SNS community is a network based on user associations. Each user in the SNS community is associated with other users in the SNS community through a certain social relation, such as a student relationship, a colleague relationship, a friend relationship, and the like. All contents in the SNS community are obtained by means of sharing from the users of the SNS community, since the SNS community per se is just a platform providing services of user association. Accordingly, the richness of the contents in the SNS community depends on the activity level of the users.

In the traditional SNS community, the activity level of an SNS community user is usually measured by the number of writing operations performed within a unit of time. The number of writing operations performed by the user represents the amount of the shared resources. Within a unit of time, more frequent writing operations by the user means the higher activity level, while less frequent writing operations by the user means the lower activity level. A user who has not performed a writing operation for a long time (i.e. a user who does not engage in social activities in the SNS community for a long time) is defined as an inactive user, and a user who frequently performs writing operations is defined as an active user. The operation for activating the inactive user is often needed in order to increase the activity level of the SNS community user and prevent the loss of users in the SNS community.

The traditional method for sending prompt information to SNS community users includes: marking a user as an inactive user based on an access record of the user, and then periodically sending an unchanged message to the inactive user in order for prompting the inactive user to perform a writing operation, thereby activating the inactive user. However, the traditional method for activating an inactive user has a poor activation effect since the prompt message sent to the inactive user has a weak association with the inactive user.

### SUMMARY OF THE INVENTION

In view of this, there is a need to provide a method for sending prompt information to SMS community users, which can improve the success rate of activating the SMS community users.

A method for sending prompt information to SNS community users, includes steps of:

identifying an inactive user in an SNS community;

acquiring a friend relationship chain of the inactive user;

identifying an active user in the friend relationship chain;

acquiring a writing operation of the active user; and

sending prompt information related to the writing operation of the active user to the inactive user.

In addition, there is also a need to provide a system for sending prompt information to SMS community users, which can improve the success rate of activating the SMS community users.

A system for sending prompt information to SMS community users, includes:

an inactive-user acquisition module for identifying an inactive user in an SNS community;

a search module for acquiring a friend relationship chain of the inactive user;

a matching module for identifying an active user in the friend relationship chain;

a writing operation acquisition module for acquiring a writing operation of the active user; and

a prompt module for sending prompt information related to the writing operation of the active user to the inactive user.

With the method and system for sending prompt information to SNS users mentioned above, the active user in the friend relationship chain of the inactive user is identified, so that when the active user performs a writing operation, the prompt information related to the writing operation performed by the active user is sent to the inactive user. Because of the friend relationship between the active user and the inactive user, the inactive user is activated by the active user which is in the friend relationship chain of the inactive user, so that the prompt information sent to the inactive user is closely associated with the inactive user, and the inactive user more likely performs a writing operation when receiving the prompt information, thus improving the success rate of activating the inactive user, and increasing the activity level of the user in the SNS community, so as to prevent the loss of a user in the SNS community.

### DESCRIPTION OF DRAWINGS

FIG. 1 is a flow chart illustrating a method for sending prompt information to an SNS community user according to an embodiment;

FIG. 2 is a schematic diagram showing the structure of a system for sending prompt information to an SNS community user according to an embodiment; and

FIG. 3 is a schematic diagram showing the structure of the system for sending prompt information to an SNS community user according to another embodiment.

### DETAILED DESCRIPTION OF THE PREFERRED EMBODIMENT

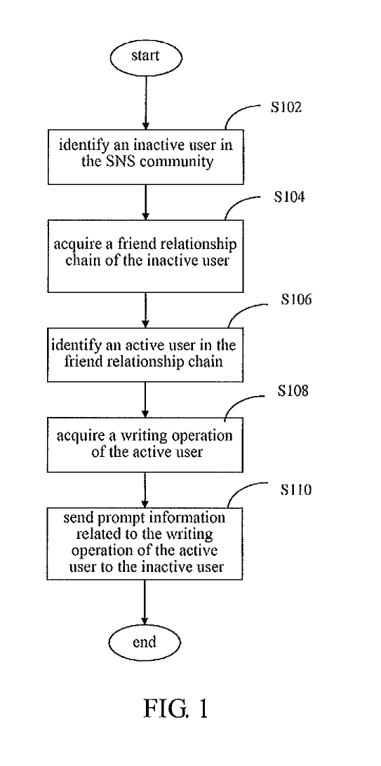

In an embodiment, as shown in FIG. 1, a method for sending sending prompt information to an SNS community user includes the following steps S102 to S110.

In the step S102, an inactive user in the SNS community is identified.

In an embodiment, before the inactive user in the SNS community is identified, the method further includes: acquiring the number of writing operations performed by a user in the SNS community within a preset time period, and recording an inactive user, of which the number of performed writing operations is less than a first threshold, into an inactive-user library.

For example, the preset time period may be one week, and the first threshold is set to 2; if the number of the writing operations performed by a user within one week is no more than 2, then the user is record in the inactive-user library. Specifically, it is possible to record a user identifier of the inactive user in the inactive-user library. Further, the inactive-user library may be updated periodically or nonperiodically.

In the step S102, the user identifier of the inactive user may be acquired directly from the inactive-user library.

In the step S104, a friend relationship chain of the inactive user is acquired.

In the SNS community, a user can build friend relationship(s) with one or more other users, thus the other users in the friend relationship with said user constitute the friend relationship chain of said user. The friend relationship chain of a user is stored in a database in the form of a friend list corresponding to the user identifier of the user.

In an embodiment, the corresponding friend relationship chain is extracted from the database based on the user identifier of the inactive user.

In the step S106, an active user in the friend relationship chain is identified.

Compared with the inactive user, the active user refers to a user from the SNS community which performs many writing operations. Specifically, a user, which is not the inactive user, is the active user. In an embodiment, an active-user library for recording the user identifier of the active user therein can be also built.

In the step S106, after the corresponding friend relationship chain is acquired according to the user identifier of the inactive user, an active user recorded in the active-user library is acquired from the friend relationship chain.

In the step S108, a writing operation of the active user is acquired.

To engage in a social activity in the SNS community, a user may perform a writing operation, such as log posting, picture uploading, link sharing, and the like.

In the step S110, prompt information related to the writing operation of the active user is sent to the inactive user.

Specifically, after the writing operation of the active user is acquired, the prompt information related to the writing operation of the active user is generated according to the writing operation of the active user, and then sent to the corresponding inactive user. For example, if an active user has posted a travel log, then prompt information of “Your friend xx has posted a travel log in the SNS community” is generated and sent to the inactive user.

Further, the prompt information may be sent to the inactive user through an e-mail, a Short Message Service (SMS) message and/or instant messaging.

In addition, the prompt information may also be transmitted in real time by amending an interface for the writing operation of the active user. That is, a functional approach of sending the prompt information may be defined in the interface used by the active user to perform the writing operation. When the interface for the writing operation is invoked by the active user to perform the writing operation, the prompt information related to the writing operation is sent to the corresponding inactive user.

In another embodiment, before the step S102, a user in the friend relationship chain, of which the number of interactions performed with the inactive user exceeds a second threshold, may be identified and recorded in a close-friend library.

In the SNS community, the number of interactions performed between two users may be represented by the number of data exchanges between the two users, such as reciprocal transmission of messages, reciprocal forwarding of posts, and reciprocal visiting to home pages. The greater number of performed interactions represents a closer association between the two users. A user, of which the number of interactions performed with another user exceeds the second threshold, is regarded as a close friend of said another user.

In fact, for any user in the SNS community, a friend of said user, of which the number of interactions performed with said user exceeds the second threshold, may be recorded (as a so called close friend) in the close-friend library. Specifically, the user identifier and the corresponding close-friend list are recorded in the close-friend library.

In the present embodiment, in identifying the active user from the friend relationship chain, the active user which is in the friend relationship chain and also recorded in the close-friend library may be identified. In acquiring a writing operation of the active user from the friend relationship chain, the writing operation of the active user which is in the friend relationship chain and also recorded in the close-friend library is acquired. Since the friends in the close-friend library of an inactive user are more closely associated with the inactive user, the writing operations performed by the friends in the close-friend library are more closely associated with the inactive user, and the success rate of activating the inactive user by these active users (i.e. the friends) can be much improved.

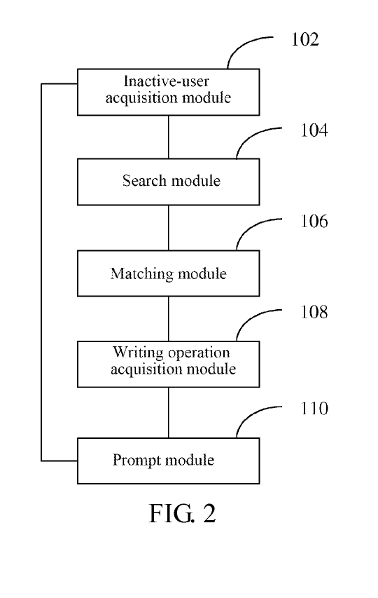

In an embodiment, as shown in FIG. 2, a system for sending prompt information to SNS community users includes an inactive-user acquisition module 102, a search module 104, a matching module 106, a writing operation acquisition module 108 and a prompt module 110.

The inactive-user acquisition module 102 is configured to identify an inactive user in the SNS community.

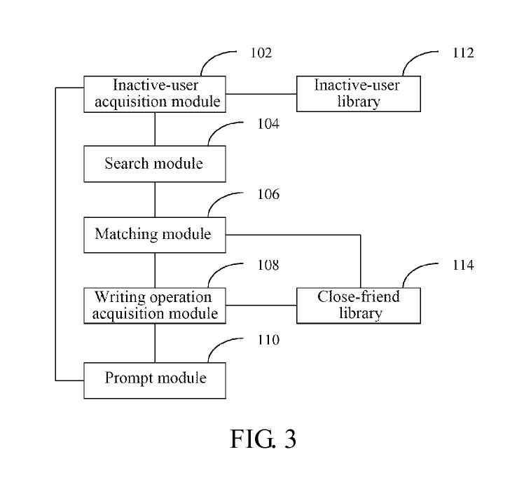

In an embodiment, as shown in FIG. 3, the system for sending prompt information to SNS community users further includes an inactive-user library 112 used for acquiring the number of writing operations performed by a user in the SNS community within a preset time period, and recording an inactive user, of which the number of performed writing operations is less than a first threshold.

For example, the preset time period is one week, and the first threshold is set to 2; if the number of the writing operations performed by a user within one week is no more than 2, then the user is recorded in the inactive-user library as an inactive user,. Specifically, the inactive-user library 112 is configured to record the user identifier of the inactive user. Further, the inactive-user library 112 may be updated periodically or nonperiodically.

In an embodiment, the inactive-user acquisition module 102 is configured to acquire the user identifier of the inactive user from the inactive-user library 112.

The mapping module 104 is configured to acquire a friend relationship chain of the inactive user.

In the SNS community, a user can build friend relationship(s) with one or more other users, thus the other users in the friend relationship with the said constitute the friend relationship chain of said user. The friend relationship chain of a user is stored in a database (not shown) in the form of a friend list corresponding to the user identifier of the user.

In an embodiment, the mapping module 104 is configured to extract the corresponding friend relationship chain from the database based on the user identifier of the inactive user.

The matching module 106 is configured to identify an active user in the friend relationship chain.

Compared with the inactive user, the active user refers to a user from the SNS community which performs many writing operations. Specifically, a user, which is not the inactive user, is the active user. In an embodiment, the system for sending prompt information to SNS community users described above may further include an active-user library (not shown) used for recording the user identifier of the active user. The matching module 106 then is configured to identify, from the friend relationship chain, the active user recorded in the active-user library.

The writing operation acquisition module 108 is configured to acquire a writing operation of the active user.

To engage in a social activity in the SNS community, a user may perform a writing operation, such as log posting, picture uploading, link sharing, and so on. The writing operation acquisition module 108 then is configured to acquire the writing operation performed by the active user.

The prompt module 110 is configured to send prompt information related to the writing operation of the active user to the inactive user.

Specifically, after the writing operation of the active user is acquired, the prompt module 110 generates, based on the writing operation of the active user, the prompt information related to the writing operation of the active user, and sends the prompt information to the corresponding inactive user. For example, if an active user has posted a travel log, then the prompt information of “Your friend xx has posted a travel log in the SNS community” is generated and sent to the inactive user.

Further, the prompt module 110 may be configured to send the prompt information to the inactive user through an e-mail, an SMS message and/or instant messaging.

In addition, by amending the interface for the writing operation of the active user, the prompt module 110 may also be configured to transmit the prompt information in real time. That is, a functional approach of sending the prompt information may be defined in the interface used by the active user to perform the writing operation. When the interface for the writing operation is invoked by the active user to perform the writing operation, the prompt information related to the writing operation is sent to the corresponding inactive user.

In another embodiment, as shown in FIG. 3, the system for sending prompt information to SNS community users further includes a close-friend library 114, which is used for identifying and recording a user from the friend relationship chain, of which the number of interactions performed with the inactive user exceeds a second threshold.

In the SNS community, the number of interactions performed between two users may be represented by the number of data exchanges between the two users, such as reciprocal transmission of messages, reciprocal forwarding of posts, and reciprocal visiting to home pages. The greater number of performed interactions represents a closer association between the two users. A user, of which the number of interactions performed with another user exceeds the second threshold, is regarded as a close friend of said another user.

In fact, for any user in the SNS community, a friend of said user, of which the number of interactions performed with said user exceeds the second threshold, may be recorded as a so called close friend) in the close-friend library 114. Specifically, the user identifier and the corresponding close-friend list are recorded in the close-friend library 114.

In the present embodiment, the matching module 106 is configured to identify the active user which is in the friend relationship chain and also recorded in the close-friend library 114. The writing operation acquisition module 108 is configured to acquire the writing operation of the active user which is in the friend relationship chain and also recorded in the close-friend library 114. Since the friends in the close-friend library of an inactive user are more closely associated with the inactive user, the writing operations performed by the friends are more closely associated with the inactive user, and the success rate of activating the inactive user by these active users (i.e. the friends) can be much improved.

The invention further provides a computer storage medium containing mobile terminal-executable instructions, which are used to control the mobile terminal to perform a page switching method in the above interactive interface. The specific steps of the image management method performed by the mobile terminal-executable instructions in the computer storage medium are the same as those in the above method, and are not described again hereinafter.

The above embodiments are described merely for illustrating the implementations of the present invention, but shall not be interpreted as the limitation on the scope of present invention despite of the relatively specific and detailed description of the embodiments. It is noted that those skilled in the art can make variations and modifications without departing from the inventive concept of the present invention, and all the variations and modifications fall within the scope of the present invention. Accordingly, the scope of the present invention is defined by the attached claims.

1. A method for sending prompt information to SNS community users, comprising steps of:
identifying an inactive user in an SNS community ;
acquiring a friend relationship chain of the inactive user;
identifying an active user in the friend relationship chain;
acquiring a writing operation of the active user; and
sending prompt information related to the writing operation of the active user to the inactive user.

2. The method of claim 1, before the step of identifying the inactive user in the SNS community, further comprising:
building an inactive-user library; and
acquiring the number of writing operations performed by a user in the SNS community within a preset time period, and recording, in the inactive-user library, an inactive user of which the number of performed writing operations is less than a first threshold;
wherein, the step of identifying the inactive user comprises identifying the inactive user from the inactive-user library.

3. The method of claim 2, further comprising:
updating the inactive-user library periodically or nonperiodically.

4. The method of claim 2, wherein the step of identifying the inactive user in the SNS community comprises:
acquiring a user identifier of the inactive user from the inactive-user library.

5. The method of claim 1, before the step of identifying the inactive user in the SNS community, further comprising:
identifying a user in the friend relationship chain, of which the number of interactions performed with the inactive user exceeds a second threshold, and recording, in a close-friend library, the user of which the number of interactions performed with the inactive user exceeds the second threshold;
wherein, the step of identifying an active user in the friend relationship chain comprises: identifying an active user which is in the friend relationship chain and also recorded in the close-friend library.

6. The method of claim 5, wherein the number of performed interactions is the number of data exchanges between the two users;
the data exchanges include reciprocal transmission of messages, reciprocal forwarding of posts, and reciprocal visiting to home pages.

7. The method of claim 1, wherein the writing operation performed by the active user includes log posting, picture uploading, and link sharing.

8. The method of claim 1, wherein the step of sending prompt information related to the writing operation of the active user to the inactive user comprises:
sending the prompt information to the inactive user through an e-mail, an SMS message and/or instant messaging.

9. The method of claim 1, wherein the step of sending prompt information related to the writing operation of the active user to the inactive user comprises:
transmitting the prompt information to the inactive user in real time by amending an interface for the writing operation of the active user.

10. A system for sending prompt information to SMS community users, comprising:
an inactive-user acquisition module for identifying an inactive user in an SNS community;
a search module for acquiring a friend relationship chain of the inactive user;
a matching module for identifying an active user in the friend relationship chain;
a writing operation acquisition module for acquiring a writing operation of the active user; and
a prompt module for sending prompt information related to the writing operation of the active user to the inactive user.

11. The system of claim 10, further comprising:
an inactive-user library for acquiring the number of writing operations performed by a user in the SNS community within a preset time period, and recording an inactive user of which the number of performed writing operations is less than a first threshold.

12. The system of claim 11, wherein the inactive-user library is further updated periodically or nonperiodically.

13. The system of claim 11, wherein the inactive-user acquisition module is also configured to acquire a user identifier of the inactive user from the inactive-user library.

14. The system of claim 9, further comprising a close-friend library used for identifying and recording a user from the friend relationship chain, of which the number of interactions performed with the inactive user exceeds a second threshold; and the matching module is further configured to identify the active user which is in the friend relationship chain and recorded in the close-friend library.

15. The system of claim 14, wherein the number of interactions represents the number of data exchanges between the two users;
the data exchanges include reciprocal transmission of messages, reciprocal forwarding of posts, and reciprocal visiting to home pages.

16. The system of claim 10, wherein the writing operation performed by the active user includes log posting, picture uploading, and link sharing.

17. The system of claim 10, wherein the prompt module is further configured to send the prompt information to the inactive user through an e-mail, an SMS message and/or instant messaging.

18. The system of claims 10, wherein the prompt module is further configured to transmit the prompt information to the inactive user in real time by amending an interface for the writing operation of the active user.

19. The method of claim 2, wherein the writing operation performed by the active user includes log posting picture uploading, and link sharing.

20. The method of claim 2, wherein the step of sending prompt information related to the writing operation of the active user to the inactive user comprises:
sending the prompt information to the inactive user through an e-mail, an SMS message and/or instant messaging.

21. The method of claim 2, wherein the step of sending prompt information related to the writing operation of the active user to the inactive user comprises:
transmitting the prompt information to the inactive user it real time by amending an interface for the writing operation of the active user.

22. The system of claim 11, wherein the writing operation performed by the active user includes log posting picture uploading, and link sharing.

23. The system of claim 11, wherein the prompt module is further configured to send the prompt information to the inactive user through an e-mail, an SMS message and/or instant messaging.

24. The system of claim 11 wherein the prompt module is further configured to transmit the prompt information to the inactive user in real time by amending an interface for the writing operation of the active user.
